(19) United States
(12) Patent Application Publication
(10) Pub. No.: US 2020/0015451 A1
(43) Pub. Date: Jan. 16, 2020

(54) SPILL PROOF OUTDOOR DOG BOWL WITH REMOVABLE SPIKES

(71) Applicant: NEIL ACKERMAN, Bolingbrook, IL (US)

(72) Inventor: NEIL ACKERMAN, Bolingbrook, IL (US)

(21) Appl. No.: 16/035,602

(22) Filed: Jul. 14, 2018

(51) Int. Cl. A01K 7/00

(52) U.S. Cl. CPC A01K 7/005

(57) ABSTRACT

A bowl for a pet, such as a dog or any other animal, that is secured into the ground (grass or dirt) with removable spikes. A flange at the bottom of the bowl surrounds the entire perimeter and has two holes on each side for which a six inch spike can be placed through to secure the bowl into the ground, preventing the pet from flipping or spilling the bowl. When the bowl is used on a hard surface such as wood or concrete, the spikes can easily be removed. When picking up the dog bowl, there are handles on each side in the form of partial flanges that is only on each side. These handles allows the dog bowl to be picked up without touching the contents within the bowl such as slobber.

### BACKGROUND OF THE INVENTION

### Field of the Invention

In general, the present invention relates to dog bowls and other such animal feeding bowls. More particularly, the present invention relates to the structure of dog bowls that prevents an animal, such as a dog, from tipping, spilling, or moving said bowl, containing food or water.

### Prior Art Statement

Dogs, amoung other pets, who are left alone outside for long periods of time, such as when the pet owner is at work, has a tendency to flip the water or food bowl over, spilling the contents of said bowl. With the water spilled from the bowl, the water would soak into the ground or evaporate, causing the pet to become dehydrated. This placed the pet in a dangerous situation, especially in the extreme heat during the summer months.

The prior art is replete with different types of specialized bowls and containers that are designed to reduce the amount of spillage that occurs from a dog bowl. However, the majority of these prior art designs are for indoor use only and would be ineffective for outdoor use. For example, the dish may have suction cups below, securing it onto a hardwood or tiled floor. As Another example, the dish may include a sticky surface or other treatment on the bottom. This approach relies on a frictional engagement with the floor, however; this cannot work on grass or dirt. The most common outdoor dog bowl is a regular stainless steel bowl. However, medium to large size dogs have a tendency to step on the rim of said bowl, causing it to spill.

A need therefore exists in the art for a different and superior approach to prevent spillage from a pet's food or water bowl. This need is met by the present invention as described and claimed below.

### SUMMARY OF THE INVENTION

An exemplary embodiment of the invention is to provide a bowl that can be secured into the ground with removable spikes, preventing it from flipping or tipping over.

The present invention is a standard food or water bowl that has a flange at the bottom of said bowl, with a hole on each side in the flange, for a six (6) inch spike to go through and secure it into the ground. When the spikes are affixed to the bowl, it will prevent the dog, and/or other pet from tipping or spilling the water or food within the bowl. These spikes can be removed when using the bowl on hard surfaces, such as concrete, wood, or even indoors.

### BRIEF DESCRIPTION OF THE DRAWING

For a better understanding of the present invention, reference is made to the following descriptions of exemplary embodiments thereof, considered in conjunction with the accompanying drawings, in which:

FIG. 1 depicts a side view of the dog bowl with the spikes attached;

FIG. 2 depicts a side view of the dog bowl with the spikes removed;

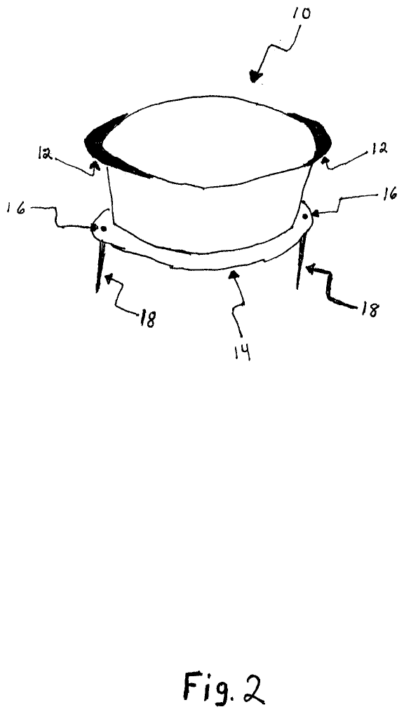

FIG. 3 is a top view of the dog bowl with the spikes removed showing the holes where the spikes would go into, to secure it into the ground;

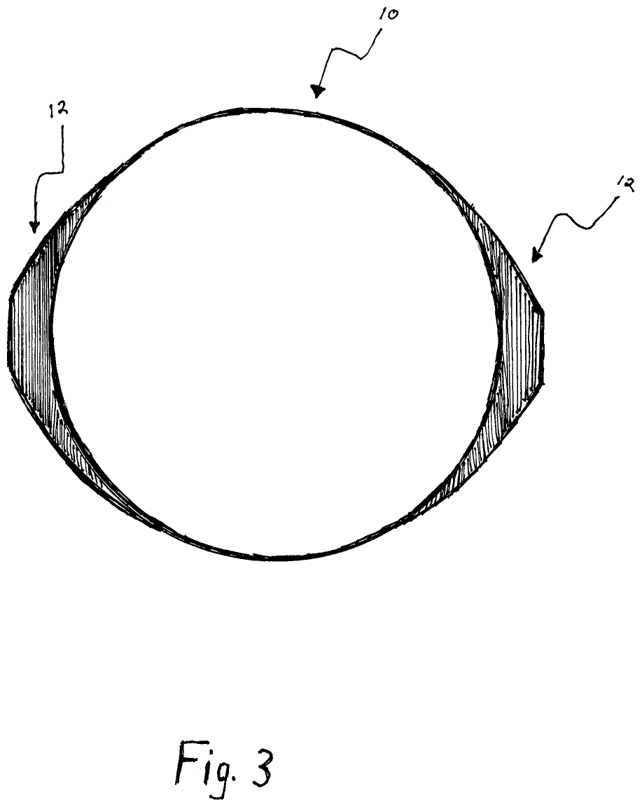

FIG. 4 is a view of the hole where the spike secures the bowl, along with the spike;

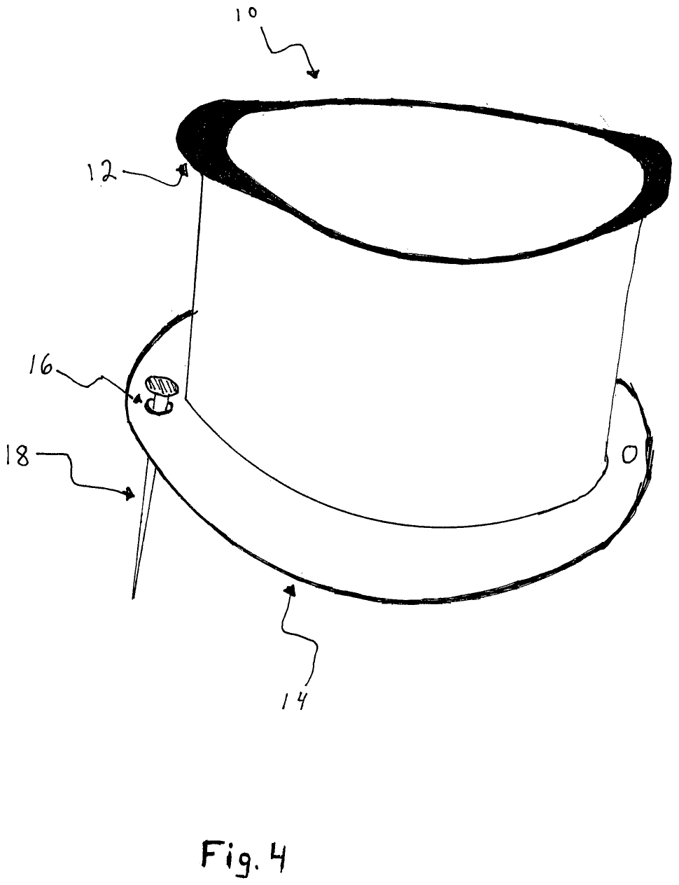

FIG. 5 depicts the spike used to secure the bowl into the ground.

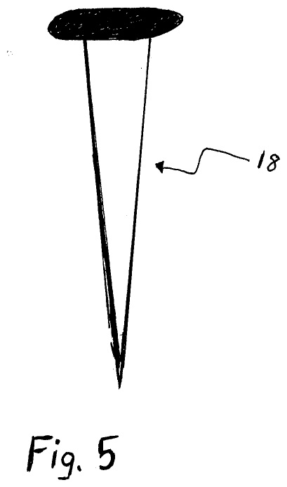

### DETAILED DESCRIPTION OF THE INVENTION

Although the present invention depicts a round dog bowl, it could be applied to any type and size bowl. Accordingly, in the exemplary embodiments of the invention that are shown, the present invention is shown with a traditional round dog bcw1.10.

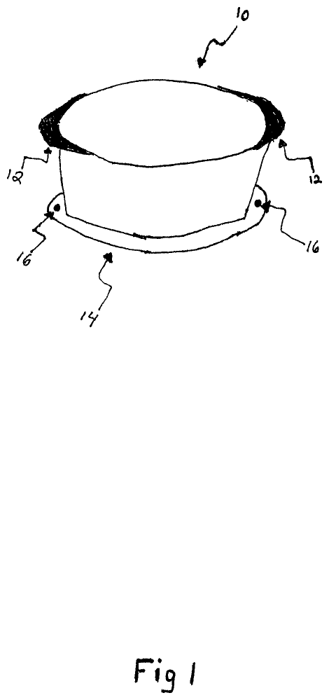

Referring to FIG. 1, shows an exemplary embodiment of the invention where the bowl has two handles one on each side 12. These handles makes it easy to pick up the dog bowl, without getting slobber on your hands. On most dog bowls, the pet owner (or family member) grabs the rim of the bowl when picking up said bowl. This area is usually dirty from food or slobber.

The average diameter of a dog bowl 10 is typically between six inches and ten inches. Most medium to large dogs have a habit of stepping onto the rim of the dog bowl, causing it to flip over and spilling its contents. To prevent this from occurring, this dog bowl 10 has a flange 14 around the bottom of the dog bowl 10. This flange 14 extends out approximately 12 inches around the bottom of the dog bowl 10, extending the bottom of the bowl. On this flange 14, there are two holes 16, one on each side, where spikes 18 go through the holes 16, securing the dog bowl 10 into the ground, preventing the dog bowl 10 from flipping over.

When the dog bowl 10 is used on hard surfaces such as a deck or porch (wood surface), or on a concrete patio, the spikes 18 can be easily removed from the holes 16. Once the spikes 18 are removed, the dog bowl 10 can rest flat on the hard surface, just like any ordinary bowl. However, without the spikes 18, the dog bowl 10 will not be secured and subjected to being flipped and/or moved, spilling its contents. These spikes 18 are bath six inches long.

The process of making this invention would be by making it out of a hard durable plastic. A prototype will be made on a 3-D printer until a plastic mold can be made for production.

The invention claimed is:

1. An outdoor dog bowl, comprising: a bowl for food or water, with a flange that surrounds the entire bottom. This flange extends out approximately 1½ inches and has two holes, one on each side, where a spike can go through, and said spike has a wider head than the diameter of paid hole, preventing it from going all the way through, thus, securing said dog bowl on the ground. The spikes are approximately six inches-long, however, we claim any spike attached to a bowl to secure it into the ground, preventing said bowl from flipping or moving by the dog or any other pet.

2. The top of said bowl has two small handles, one on each side, in the form of a partial flange. These two handles are so the dog bowl can be picked up when filling up said bowl with food or water.
